(19) United States
(12) Patent Application Publication
(10) Pub. No.: US 2006/0022440 A1
(43) Pub. Date: Feb. 2, 2006

(54) Airbag module

(76) Inventor: Junichi Umehara, Fuji-gun (JP)

Correspondence Address: JOHN S. PRATT, ESQ;KILPATRICK STOCKTON, LLP, 1100 PEACHTREE STREET, ATLANTA, GA, 30309, US

(21) Appl. No.: 11/190,260

(22) Filed: Jul. 27, 2005

(30) Foreign Application Priority Data
Jul. 29, 2004 (JP) P2004-222499

(51) Int. Cl. B60R 21/20; B60R 21/16

(52) U.S. Cl. 280/730.1; 280/728.3

(57) ABSTRACT

An airbag module includes an airbag configured to receive a gas thereinto to develop toward lower limbs of a passenger seated. The airbag module includes a cover housing the airbag therein. The cover includes a first tear portion configured to tear by the airbag developing under pressures during development of the airbag for inflating the airbag in a first direction. The cover includes a second tear portion tearable by the airbag developing under pressures after tearing of the first tear portion for inflating the airbag in a second direction crossing the firs direction.

### CROSS-REFERENCE TO BELATED APPLICATIONS

This application is based upon and claims the benefit of priority from Japanese Patent Application No. 2004-222499 filed on Jul. 29, 2004; the entire contents of which are incorporated herein by reference.

### BACKGROUND OF THE INVENTION

This invention relates to an airbag module configured to develop, for example, toward the lower limbs of a passenger in a vehicle such as an automobile.

The document of the related art discloses an airbag module configured to develop toward the lower limbs of a passenger seated in an automobile, which is referred to as a knee airbag module (e.g., see Japanese Patent Application Publication Laid-open No. 2002-337652, FIG. 1). This airbag module is disposed in an instrument panel below a steering wheel in front of a driver seat, or alternatively, below a glove box in front of a navigator seat, for example. When a control device detects a collision impact, gas is supplied from an inflator to develop a folded and housed airbag. The developing airbag restrains the knees of a passenger, thus relieving the impact on the passenger.

The passenger, who is a protective object, is located in proximity to the airbag module, and this knee airbag module includes a control device having a sensor in order to correct a load to be exerted on the passenger. This control device detects the condition of the passenger, and adjusts the output of the inflator.

### SUMMARY OF THE INVENTION

This control device is complex and costly, thus making it difficult to reduce manufacturing costs.

This invention is directed to an airbag module configured to suppress pressure to be imposed on a protective object with a simple structure, where an airbag develops toward the lower limbs of a passenger.

The first aspect of the invention provides the following airbag module. The airbag module includes an airbag configured to receive a gas thereinto to develop toward lower limbs of a passenger seated. The airbag module includes a cover housing the airbag therein. The cover includes a first tea portion configured to tear by the airbag developing under pressures during development of the airbag for inflating the airbag in a first direction. The cover includes a second tear portion tearable by the airbag developing under pressures after tearing of the first tear portion for inflating the airbag in a second direction crossing the first direction.

The airbag module may include an inflator configured to supply the gas into the airbag. The airbag module may include a support member supporting the inflator, the airbag, and the cover. The cover may include a front side having the first tear portion. The cover may include a support piece having the second tear portion, extending in a direction crossing the front side, and being fitted to the support member.

The first direction may be directed to the limbs of the passenger. The second direction may be directed to a floor of a vehicle body.

The second aspect of the invention provides the following airbag module. The airbag module includes an airbag developable below a steering wheel in front of a front seat of a vehicle.

The airbag module includes a cover housing the airbag therein. The cover includes a first tear portion tearable by the airbag developing. The cover includes a second tear portion tearable by the airbag developing after tearing of the first tear portion.

The cover may include a first wall having the first tear portion. The cover may include a second wall having the second tear portion and facing in a different direction from the first wall.

The first tear portion may be weaker in strength than the second tear portion.

The first tear portion may be thinner than the second tear portion

According to the aspects, when the gas is supplied to the airbag, the airbag developing tears the first tear portion of the cover under pressures. The tear allows the airbag to inflate in the first direction for developing toward the limbs of the passenger seated, thus restraining the limbs of the passenger for protection. The limbs of the passenger prevent development of the airbag that has torn the first tear line to inflate. When the pressures become greater, the second tear portion is torn, allowing the airbag to inflate in the second direction crossing the first direction. The second-direction inflation suppresses larger pressures to be imposed on the passenger as a protective object. Thus, the structure simplifies, thus facilitating reduction in manufacturing costs.

The cover and support piece easily establishes inflation of the airbag in the crossing direction when the airbag develops.

When the limbs of the passenger prevent the airbag from developing, the structure easily establishes an appropriate load to be imposed on the passenger.

### BRIEF DESCRIPTION OF THE ACCOMPANYING DRAWINGS

FIG. 1 is a cross-sectional view of an airbag module according to an embodiment of the invention, where first and second tear lines are torn to develop an air bag;

FIG. 2 is a cross-sectional view of the airbag module of FIG. 1, where the airbag is housed;

FIG. 3 is a cross-sectional view of the airbag module of FIG. 2, where the first tear line is torn so as to develop the airbag;

FIG. 4 is an exploded perspective view of the casing and the cover of the airbag module of FIG. 2;

FIG. 5A is a development inner view of the front board and the bottom board inside the cover, which illustrates the respective tear lines; and

FIG. 5B is a development inner view of the front board and the bottom board inside the cover, which illustrates tear lines of another aspect.

### DETAILED DESCRIPTION OF THE PREFERRED EMBODIMENTS

The airbag module according to an embodiment of the invention will be described with reference to the accompanying drawings.

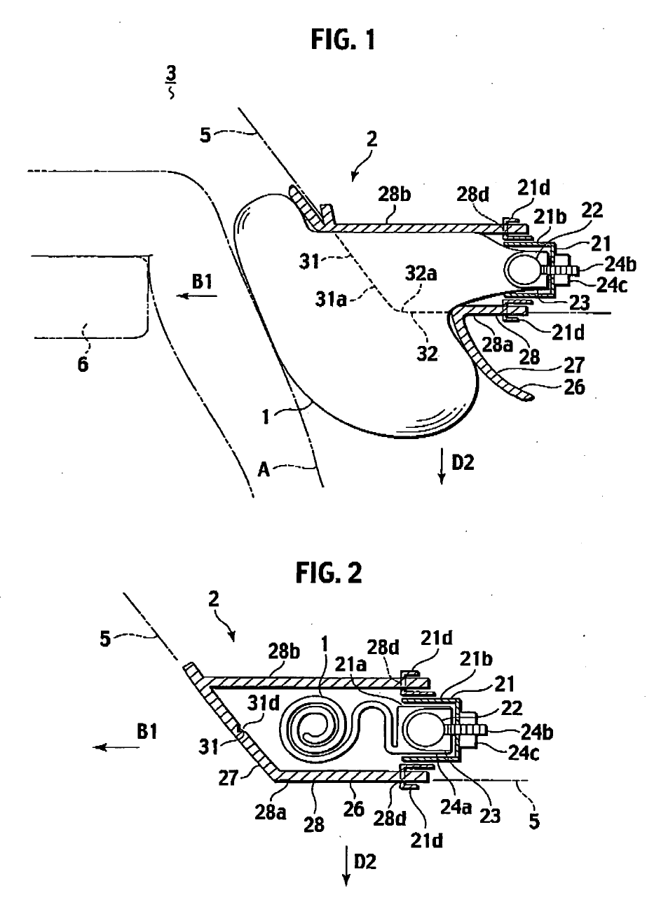

As illustrated in FIG. 1 to FIG. 3, an airbag module 2 with an airbag 1 is equipped to a panel 5 or a mounting face portion that faces the passenger compartment of the vehicle body of an automobile as a mounted member. This airbag module 2 faces the lower limbs of a passenger A including the knees as indicated with a chain double-dashed line in FIG. 1, and is referred to as a knee airbag module. The airbag module 2 develops to the underfoot of the passenger A to protect the legs of the passenger A when being subjected to an impact of a frontal collision.

In the following, directions such as a longitudinal direction will be based on the straightforward direction of a vehicle body 3. Specifically, the direction to the passenger A as a first direction will be defined as a backward direction B1. The opposite direction to this backward direction B1 will be defined as a forward direction. The direction to a floor as a second direction will be defined as a downward direction D2. The width direction of the vehicle body 3 will be defined as a transverse direction.

This vehicle body includes a pair of seats 6 on both sides in the compartment, where the passengers A can be seated. The seats 6 have a front glass and the panel 5 disposed in front thereof The upper part of this panel 5 is continuous with an instrument panel, and the lower part thereof extends forwardly. The airbag modules 2 are located at the corners of this panel 5 and are fitted so as to face the respective seats 6. Specifically, each front face side of the airbag modules 2 faces the lower limbs of the passenger A including the knees, and the lower side thereof faces a non-illustrated bottom face, i.e. a floor through a space. One of the seats 6 is a driver seat, which includes a steering wheel disposed on the upper side of the airbag module 2. The other seat is a navigator seat, which includes a glove box disposed on the upper side of the airbag module 2. In addition to the airbag modules 2, this compartment includes non-illustrated airbag modules that are located at the steering wheel, the instrument panel, the side parts of the seats, and roof side rails.

Each of the airbag modules 2, as illustrated in FIG. 1 to FIG. 4, includes a casing 21 as a support member. The airbag module 2 includes an inflator 22, a retainer 23, the airbag 1, and a cover 26 to be fitted to this casing 21. The casing 21 is also referred to as a base or a housing, and includes a box-shaped body 21b in which a rear face is formed into an opening 21a. The upper and lower faces of this body 21b are provided with fitting pieces 21d. In addition, this casing 21 is fixed and fitted to the vehicle body by use of a non-illustrated bracket The cylindrical inflator 22 includes a gas injector in proximity to the longitudinal end. The inflator 22 includes an electric connector at the other end. This inflator 22 is connected to the control device using a harness connected to the connector. The inflator 22 responds to a start signal supplied from the control device through this harness to inject gas from the gas injector. The tubular retainer 24 includes a retainer body 24a for retaining the inflator 22. The retainer 24 includes a pair of fitting bolts 24b that are welded and fixed to this retainer body 24a. These fitting bolts 24b are screwed into nuts 24c, thereby fitting the retainer 24 to the casing 21. Further, the retainer body 24a includes a gas circulation hole to allow the gas to circulate therethrough.

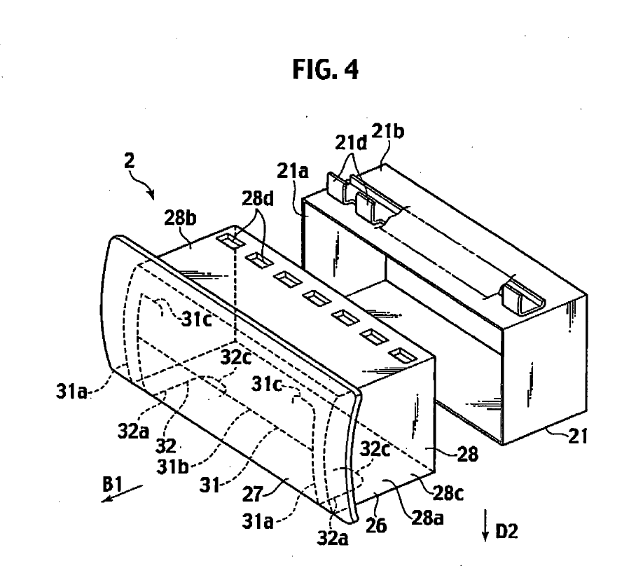

The cover 26 is referred to as a cap or a lid The cover 26 is formed integrally by use of a synthetic resin, for example. The cover 26, as illustrated in FIGS. 2 and 4, includes a front board 27 as a front part. The cover 26 includes a fitting board 28 as a support piece forwardly protruding from the rear face side of this front board 27, i.e. the front side. The front board 27 has a curved surface along the instrument panel. On the rear face side, i.e. the front side, the front board 27 includes a recessed first tear line 31 as a first tear portion, which is weaker than other portions of this front board 27. The fitting board 28 in the rectangular tube shape includes a bottom board 28a, a top board 28b, and side boards 28e on both sides. The bottom board 28a and the top board 28b include fitting receivers 28d as rectangular holes so as to correspond to the fitting pieces 21d. Continuously with the first tear line 31, the bottom board 28a includes a second tear line 32 as a second tear portion, which is weaker than other portions of the fitting board 28. The fitting board 28 is fitted to the outside of the body 21b, and the fitting pieces 21d are engaged with the fitting receivers 28d. In this state, the cover 26 is fitted to the cover 21 and the opening 21a is covered with the front board 27.

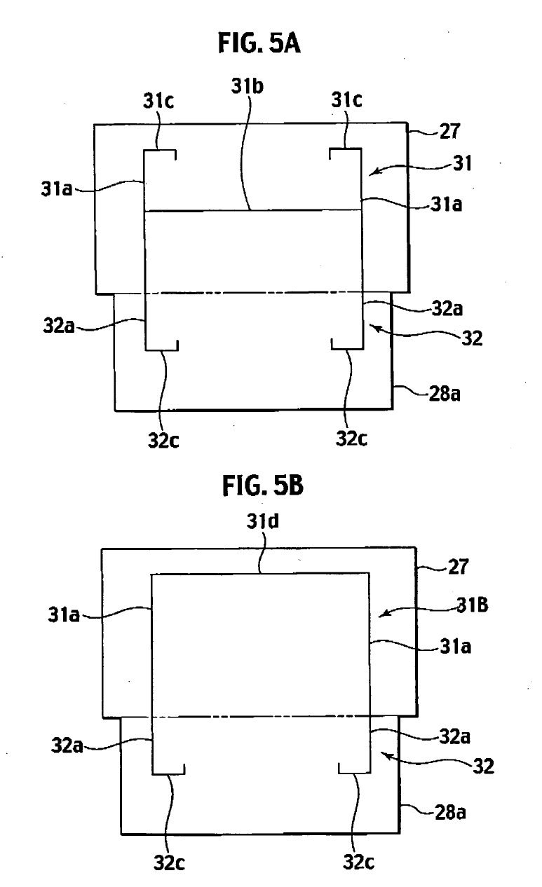

As illustrated in FIGS. 4 and 5A, the first tear line 31 has an H-shape as viewed from the front. The first tear lie 31 includes side tear lines 31a extending vertically in proximity to both sides of the portion surrounded by the fitting board 28. The first tear line 31 includes a horizontal tear line 31b that connects the vertical intermediate portions of the side tear lines 31a to each other. Moreover, the upper ends of the respective side tear lines 31a are bent and folded to come close to each other in a direction, serving as tear stoppers 31c to stop the tearing. The second tear line 32 includes a pair of straight bottom tear lines 32a on both sides. The bottom tear lines 32a are continuous with respective lower ends of the side tear lines 31a and extend in the longitudinal direction while recessing the inner face of the fitting board 28, i.e. the upper face of the bottom board 28a The second tear line 32 includes, on the ends on the front side of these bottom tear lines 32a, tear stoppers 32c to stop the tearing. Moreover, this second tear line 32 is recessed shallower than the first tear line 31. That is, the second tear line 32 is formed into a larger thickness dimension than the first tear line 31 by use of the resin. The second tear line 32 tends to tear less than the first tear line 31 to be torn under a predetermined force. The second tear line 32 is torn when a force larger than the predetermined force is exerted thereon. In this embodiment, the portion of the first tear line 31 for instance has a thickness dimension of 0.3 mm. The portion of the second tear line 32 for instance has a thickness dimension of 0.8 mm. For example, where the portion of the first tear line 31 has a thickness dimension set to 0.3 mm, the portion of the second tear line 32 has the thickness dimension for instance set in a range from 0.3 mm to 1.0 mm. In this embodiment, the bottom tear line 32a of the second tear line 32 is set to 30 mm in the longitudinal dimension, for example. The portion of the fitting board 28 of the cover body 26 in proximity to the front board 27, or at least a region defined by connecting the portions provided with the bottom tear lines 32a of the second tear line 32 does not overlap the casing 21.

The airbag 1 is formed into a bag by sewing a piece of base cloth or sewing a plurality of base cloths. The airbag 1 is folded into a predetermined shape and is housed in the casing 21. This airbag 1 includes a restrictor disposed inside thereof. Where appropriate, the restrictor restricts the thickness dimension during development of the airbag and separates the inside of the airbag 1 into a plurality of compartments. The restrictor is referred to as a tether. Although it is not illustrated herein, this airbag 1 includes an insertion hole that allows for insertion of the inflator 22 into the airbag 1. The airbag 1 includes fitting holes (not illustrated) in proximity to this insertion hole.

Next, a process of assembling this airbag module 2 will be described.

Firstly, the airbag 1, the inflator 22, and the retainer 24 are combined together into an assembly. In this process, firstly the end of the inflator 22 is fitted with the harness and then the inflator 22 is fitted and fixed to the inside of the retainer body 24a. The retainer 24 fitted to this inflator 22 is inserted through the insertion hole into the airbag 1. The fitting bolts 24b are pulled out of the fitting holes. The proximal end of the airbag 1 is folded back, thus allowing the fitting bolts 24b to pass through the fitting holes. Subsequently, with the airbag 1 arranged in a shape so as to be spread as a plane, the airbag 1 is rolled from the distal end and is folded into a roll shape, while the vicinity of the retainer 24 is formed into bellows. In this state, the airbag 1 is covered with a wrapping formed of the base cloth. The airbag 1 is folded and retained in the predetermined shape, thereby fabricating the assembly.

Subsequently, this assembly is inserted into the casing 21 through the opening 21a. The fitting bolts 24b are inserted into the non-illustrated fitting holes of the casing 21. The nuts 24c are screwed with the fitting bolts 24b from the outside of the casing 21. Such screwing fixes the assembly of the airbag 1, the inflator 22, and the retainer 24 to the casing 21. Subsequently, the fitting board 28 is fitted to the outside of the body 21b and the fitting pieces 21d are engaged with the fitting receivers 28d. The cover 26 is fitted to the casing 21, allowing the front board 27 to cover the opening 21a, i.e. the airbag 1, thereby fabricating the airbag module 2.

The bracket is connected to a component on the vehicle body side, then the airbag module 2 is fitted to the vehicle body, and the front board 27 of the cover body 26 is set to be flush with the panel 5. The harness is electrically connected to the control device. This method installs the airbag module 2 in the vehicle body.

Next, operations of this airbag module 2 will be described.

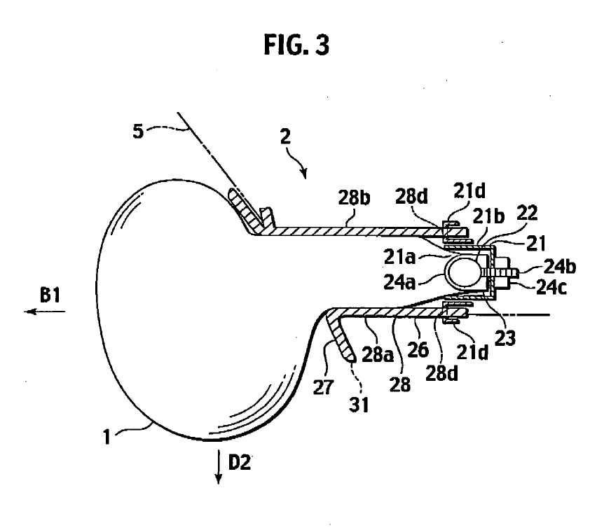

When the control device detects a collision impact of an automobile, this control device supplies electric power as a start signal through the harness, thereby activating the inflator 22. The inflator 22 supplies a gas into the airbag 1. The airbag 1 inflates inside the casing 21 to firstly tear the wrapping. Subsequently, the airbag 1 tears the front board 27 of the cover 26 on the first tear line 31 to develop into a fan shape, thereby forming a breakthrough. This breakthrough allows the airbag 1 to come out of the breakthrough toward the passenger A on the front side, i.e. to the backward direction B1. In a normal state (normal development) where the passenger is located in a regular seating position with a seat belt fastened, the airbag 1 develops in the backward direction B1. That is, the airbag 1 inflates and develops toward the lower limbs with the knees of the passenger A, who moves forward by inertia. The airbag 1 suppresses relative movement of the lower limbs to the vehicle body to restrain the lower limbs of the passenger A, thus suppressing direct contact with the panel 5 for protection. During this normal development, a large force is not exerted on the fitting board 28 disposed along the development path of the airbag 1, i.e. in the longitudinal direction of the developing direction. The second tear line 32 tends to tear less than the first tear line 31. For this reason, as illustrated in FIG. 3, the second tear line 32 remains either non-torn or slightly torn.

There may be a case where the passenger A is not located at the regular seating position and the lower limbs of the passenger A approach the airbag module 2, for example. In this case, the airbag 1 inflating out of the breakthrough to the backward direction B1 is blocked against the lower limbs of the passenger A, thereby increasing development pressure of the airbag 1. This development pressure allows for tear of the second tear line 32 provided on the bottom board 28a of the fitting board 28 (see FIG. 1). This tear allows for development of the airbag 1 to escape into a space in the downward direction D2, thereby suppressing imposition of the pressure on the passenger A.

According to this embodiment, the knee airbag module 2 includes the first tear line 31 to be torn during the normal development, as well as the second tear line 32 to be torn when the excessive load is exerted thereon. That is to say, in addition to formation of the first breakthrough by use of the first tear line 31 during the normal development, the second tear line 32 forms a second breakthrough in the direction crossing this first breakthrough during application of the excessive pressure. This second breakthrough allows the bottom face side of the cover body 26 to be opened up when an excessive load is exerted on the airbag 1, thus providing a space for the airbag 1 to escape thereinto. This space allows the blocked airbag 1 to be developed to escape in the direction crossing the direction toward the passenger A during the so-called close development. The development suppresses the pressure to be imposed on the lower limbs of the passenger A as the protective object.

The second tear line 32 tends to tear less than the first tear line 31. This structure allows the first tear line 31 to be torn during the normal development and the second tear line 32 to be torn when the excessive load is exerted thereon. This structure is easily achieved.

The airbag 1 develops toward the floor of the vehicle body, i.e. in the downward direction D2 when the excessive force is exerted thereon. This development allows the airbag 1 to escape into the space below the airbag module 2.

When compared with electronic means such as a sensor, the airbag module 2 is achieved with the simple structure of the tear line extending downwardly. Accordingly, the structure easily reduces manufacturing costs.

The embodiment has the second tear line 32 that is provided on the bottom board 28a of the fitting board 28 and that is continuous with the first tear line 31 provided on the front board 27. Without limitations to this structure, the second tear portion may separate one portion of the support piece from another portion, allowing for development of the airbag 1 in the direction crossing the direction of the development of the airbag 1, i.e. the direction of the development path. For example, the second tear portion is not limited to only the lower side of the support pieces, and may be provided at one position or multiple positions on the upper side, the left side or the right side. The positions allow the airbag 1 to develop in the manner that escapes in one direction or multiple directions. For example, the airbag 1 may develop in the right and left direction, i.e. in the traverse direction. In terms of the upper direction, the duct usually disposed above the airbag module 2 may be pushed away or crushed to ensure a space for development thereinto.

The airbag module 2 is not limited to the structure to be provided at the corner of the panel 5 and to ensure the space below. The airbag module 2 may have, at the lower part, a panel approximately flush with the front panel 27. In the case of the panel covering the lower part of the airbag module 2, developing airbag 1 may buckle the lower part of the panel and the airbag 1 may develop in the backward direction B1 of the panel, i.e. toward the passenger. Where there is a space inside a panel, i.e. in the front, the airbag may develop into this space. In the case of the airbag 1 configured to develop inside the panel, this airbag 1 may support the panel, and the airbag 1 may have a shock absorption effect with the panel. Moreover, in the case of the airbag 1 configured to develop inside the panel, the developing airbag 1 may move the panel toward the passenger in the backward direction B1.

According to the embodiment, the thickness dimension of the portion of the second tear line 32 increases more than the thickness dimension of the portion of the first tear line 31. Without limitations to this structure, the first tear portion and the second tear portion may be identical in thickness dimension with each other. Where, equalizing or varying the tendencies to tear the first tear portion and the second tear portion, the boundary between the first tear portion and the second tear portion serves as a tear stopper that tends to tear less than the first tear portion. The thickness dimension of the tear stopper is partially increased.

The first tear line 31 is formed into the H-shape as viewed from the front, and the second tear line 32 is formed into the two straight lines continuous with the first tear line 31. Without limitations to this configuration, as illustrated in FIG. 5B, a first tear line 31B may be formed into a C-shape as viewed from the front, in which the upper ends of the side tear lines 31a on both sides are connected to each other by the horizontal tear line 31d.

In addition to the airbag modules to be installed in vehicles, this invention is applicable to airbag modules to be installed in movable bodies other than vehicles.

Although the invention has been described above by reference to certain embodiments of the invention, the invention is not limited to the embodiments described above. Modifications and variations of the embodiments described above will occur to those skilled in the art, in light of the above teachings. The scope of the invention is defined with reference to the following claims.

What is claimed is:

1. An airbag module comprising:
an airbag configured to receive a gas thereinto to develop toward lower limbs of a passenger seated; and
a cover housing the airbag therein,
the cover comprising:
a first tear portion configured to tear by the airbag developing under pressures during development of the airbag for inflating the airbag in a first direction; and
a second tear portion tearable by the airbag developing under pressures after tearing of the first tear portion for inflating the airbag in a second direction crossing the first direction.

2. The airbag module according to claim 1, farther comprising:
an inflator configured to supply the gas into the airbag; and
a support member supporting the inflator, the airbag, and the cover,
wherein the cover comprises:
a front side having the first tear portion; and
a support piece having the second tear portion, extending in a direction crossing the front side, and being fitted to the support member.

3. The airbag module according to claim 1,
wherein the first direction is directed to the limbs of the passenger,
wherein the second direction is directed to a floor of a vehicle body.

4. An airbag module comprising:
an airbag developable below a steering wheel in front of a front seat of a vehicle; and
a cover housing the airbag therein,
the cover comprising.
a first tear portion tearable by the airbag developing, and
a second tear portion tearable by the airbag developing after tearing of the first tear portion.

5. The airbag module according to claim 4,
wherein the cover comprises:
a first wall having the fist tear portion; and
a second wall having the second tear portion and facing in a different direction from the first wall.

6. The airbag module according to claim 4
wherein the first tear portion is weaker in strength than the second tear portion.

7. The airbag module according to claim 4,
wherein the first tear portion is thinner than the second tear portion.
